(19) United States
(12) Patent Application Publication
(10) Pub. No.: US 2007/0007187 A1
(43) Pub. Date: Jan. 11, 2007

(54) Supply unit for fixing in a fuel tank

(76) Inventor: Benoit Bahl, Goetzenbruck (FR)

Correspondence Address: MAYER, BROWN, ROWE & MAW LLP, P.O. BOX 2828, CHICAGO, IL, 60690-2828, US

(21) Appl. No.: 10/557,056

(22) PCT Filed: Apr. 30, 2004
(86) PCT No.: PCT/EP04/50664

§ 371 Date: Nov. 16, 2005

(30) Foreign Application Priority Data
May 20, 2003 (DE) 103 22 621.4

(51) Int. Cl. B01D 35/26

(52) U.S. Cl. 210/172.3; 210/416.4

(57) ABSTRACT

The invention relates to a supply unit (3) for fuel, in which a filter (6) and a supply pump (5) are arranged in a common housing (4). The filter element (14) has a support ring (13), tensioned between lateral pieces (11, 12) of the supply unit (3). The support ring (13) retains a folded filter membrane (15) within a channel (7, 8) of the supply unit (3). Said supply unit (3) requries little space and is easily assembled.

### BACKGROUND OF THE INVENTION

The invention relates to a motor vehicle feed unit intended for mounting in a fuel tank, comprising a feed pump which is arranged in a housing and is intended for drawing fuel from a floor region of a surge chamber, and comprising a filter which is arranged upstream of the feed pump as seen in the flow direction.

Such feed units are usually designed to have an electric motor as a structural unit and are inserted through an opening in the fuel tank. The filter here has a conical filter cloth fitted on a pipe section and is arranged close to the floor of the surge chamber. The pipe section is produced in one piece with a side part of the feed unit. The filter element has clips for locking it to the pipe section and protrudes laterally away from the feed unit.

Disadvantages with the known feed unit are that they are complicated to assemble and have a high space requirement. The high space requirement due to the laterally projecting filter element results in the floor region of the surge chamber having to be designed with a very large surface area, which means that the feed unit is unable to draw fuel reliably when the fuel tank is virtually empty and the motor vehicle is inclined.

### BRIEF DESCRIPTION OF THE INVENTION

The problem on which the invention is based is to design a feed unit of the initially mentioned type in such a way that it can be produced and assembled in an extremely cost-effective manner and requires a particularly low space requirement in the floor region of the fuel tank. This problem is solved according to the invention in that the filter is arranged inside the housing of the feed pump.

This design allows the feed unit according to the invention to have a particularly low space requirement in its drawing region, with the result that the surge chamber in the fuel tank may have particularly small dimensions. A filter element projecting from the feed unit is therefore not required. The arrangement of the filter inside the feed unit means that no further pipe sections or clips are necessary for assembling the filter. The feed unit according to the invention can therefore be produced and assembled in a particularly cost-effective manner.

According to an advantageous development of the invention, a contributory factor in further reducing the space requirement is provided if the filter is cylindrical in shape and has its two end faces bearing against a respective side part which comprises a duct designed to allow fuel to flow through. A further advantage of this design is that the feed unit consequently has a sandwich-type structure and can therefore be assembled particularly simply.

According to an advantageous development of the invention, the filter is reliably held in its position if it has a support ring for supporting it on the side parts. In addition, the support ring serves as a spacer for the side parts, with the result that the latter can be clamped together simply during assembly. This contributes to further simplifying the assembly of the feed unit according to the invention.

According to another advantageous development of the invention, a large surface area of the effective region of the filter element can be produced simply if the filter element has a folded filter cloth.

According to another advantageous development of the invention, the fuel flow flows completely through the filter element if those ends of the ducts of the side parts that face the filter element are arranged offset relative to one another.

According to another advantageous development of the invention, the filter element can filter the fuel in a number of stages if the filter element has a plurality of superposed filter cloths. As a result, rapid clogging of the filter cloth is reliably prevented.

According to another advantageous development of the invention, the filter cloth is held reliably in its intended position with respect to the fuel flow if the filter element has support elements for securing the filter cloth.

Degassing lines of the feed pump or branches for supplying a sucking jet pump with fuel, for example, are frequently led off downward from the feed unit. According to another advantageous development of the invention, such lines can be easily led through the filter if the filter has ring elements which are mounted in the filter element and intended for leading through lines.

A contributory factor in further reducing the production costs of the feed unit according to the invention is provided if the support ring is produced from plastic by injection molding.

A contributory factor in further simplifying the assembly of the feed unit according to the invention is provided if the support ring is designed to provide lateral sealing for the filter element. This makes it possible for the feed pump and the filter together with the two side parts to be clamped together simply in a side part produced, for example, from sheet metal. The feed unit according to the invention requires particularly few components to be assembled if the support ring is produced in one piece with one of the side parts.

### BRIEF DESCRIPTION OF THE DRAWINGS

The invention allows numerous embodiments. In order to further illustrate the basic principle of the invention, two of the embodiments are represented in the drawing and described in further detail below. In the drawing:

FIG. 1 shows a floor region of a fuel tank having a feed unit according to the invention,

FIG. 2 shows an enlarged sectional representation through the lower region of the feed unit according to the invention shown in FIG. 1,

FIG. 3 shows a sectional representation through the feed unit shown in FIG. 2 along the line III-III,

FIG. 4 shows a lower region of a further embodiment of the feed unit according to the invention, in partial section.

### DETAILED DESCRIPTION OF THE INVENTION

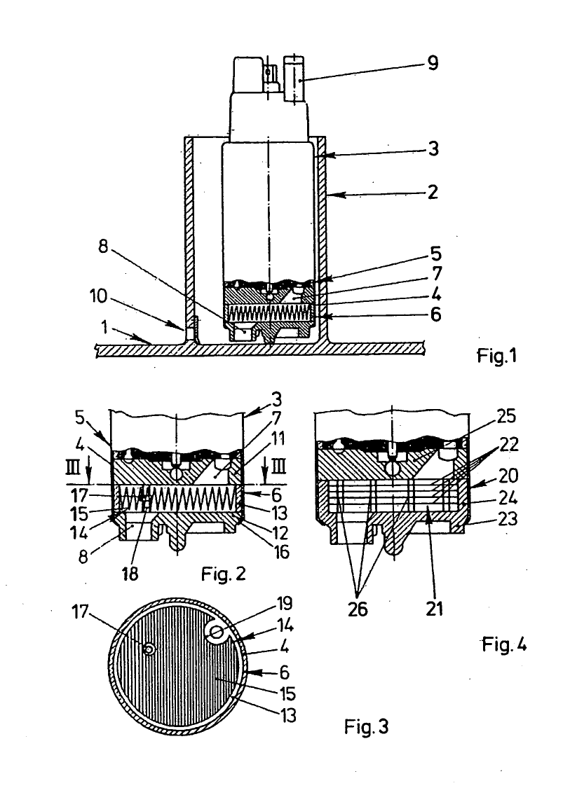

FIG. 1 shows a floor region of a motor vehicle fuel tank 1 having a surge chamber 2. A feed unit 3 having a feed pump 5 arranged in a housing 4 is mounted in the surge chamber 2. The feed pump 5 draws fuel from the floor region of the surge chamber 2 via a duct 7, 8 passing through a filter 6 and feeds this fuel to a connecting stub 9 arranged on its upper side. The connecting stub 9 can be adjoined by a forward flow line which leads to an internal combustion engine (not shown). In its lower region, the surge chamber 2 has a bottom valve 10 designed as a nonreturn valve. Fuel can flow into the surge chamber 2 through the bottom valve.

As shown in FIG. 2, the filter 6 is clamped between two side parts 11, 12 of the feed unit 3. In its radially outer region, the filter 6 has a support ring 13 produced from plastic by injection molding. The support ring 13 is adhesively bonded in a sealing manner to a filter element 14 which has a folded filter cloth 15. The housing 4 of the feed unit 3 is tubular in shape and has at its end a flanged edge 16 which engages behind the outer side part 12 of the feed unit 3. As a result, the side parts 11, 12 are clamped together with the filter 6 and the feed pump 5. The filter 6 has a ring element 17 which is incorporated in the filter cloth 15 by adhesive bonding and is intended for leading through a line 18. The line 18 may, for example, be a degassing line of the feed pump 5 or a branch leading into the fuel tank 1 represented in FIG. 1.

The feed unit 3 from FIG. 2 is represented in FIG. 3 in a sectional representation along the line III-III. It can be seen here that the support ring 13 is produced in one piece with a second ring-element 19 for leading a line (not shown) through the filter 6.

FIG. 4 shows a further embodiment of the feed unit 3 according to the invention in a partial section through a filter 20. The filter 20 here has a filter element 21 with a plurality of superposed filter cloths 22 of flat design. A side part 23 bearing against the filter 20 is produced in one piece with a support ring 24 of the filter element 21. The filter cloth 22 has a plurality of support elements 26 bearing against the side parts 23, 25.

1. A motor vehicle feed unit intended for mounting in a fuel tank, comprising a feed pump which is arranged in a housing and is intended for drawing fuel from a floor region of a surge chamber, and comprising a filter which has a filter element (14, 21) and is arranged upstream of the feed pump as seen in the flow direction, characterized in that the filter (6, 20) is arranged inside the housing (4) of the feed pump (5).

2. The feed unit as claimed in claim 1, characterized in that the filter (6, 20) is cylindrical in shape and has its two end faces bearing against a respective side part (11, 12, 23, 25) which comprises a duct (7, 8) designed to allow fuel to flow through.

3. The feed unit as claimed in claim 1 or 2, characterized in that the filter (6, 20) has a support ring (13, 24) for supporting it on the side parts (11, 12, 23, 25).

4. The feed unit as defined in claim 1, characterized in that the filter element (14) has a folded filter cloth (15).

5. The feed unit as defined in claim 2, characterized in that those ends of the ducts (7, 8) of the side parts (11, 12, 23, 25) that face the filter element (14, 21) are arranged offset relative to one another.

6. The feed unit as defined in claim 1, characterized in that the filter element (21) has a plurality of superposed filter cloths (22).

7. The feed unit as defined in claim 6, characterized in that the filter element (21) has support elements (26) for securing the filter cloth (22).

8. The feed unit as defined in claim 1, characterized in that the filter (6) has ring elements (17, 19) which are mounted in the filter element (14) and are intended for leading through lines (18).

9. The feed unit as defined in claim 3, characterized in that the support ring (13, 24) is produced from plastic by injection molding.

10. The feed unit as defined in claim 3, characterized in that the support ring (13, 24) is designed to provide lateral sealing for the filter element (14, 21).

11. The feed unit as defined in claim 3, characterized in that the support ring (24) is produced in one piece with one of the side parts (23).
